(19) United States
(12) Patent Application Publication
(10) Pub. No.: US 2011/0248228 A1
(43) Pub. Date: Oct. 13, 2011

(54) Winch and Trailer Hitch

(76) Inventor: Anthony Gause, Miramar, FL (US)

(21) Appl. No.: 12/756,030

(22) Filed: Apr. 7, 2010

(51) Int. Cl. B66D 1/00

(52) U.S. Cl. 254/323

(57) ABSTRACT

A device that mounts into a vehicle's hitch receiver on a first end and providing a hitch ball on a second end also having a winch disposed between the first and second end. The winch is preferably removable from the balance of the device for ease of installation, transport and security. When in use, the winch may be locked in any of several predetermined angles relative to the hitch receiver so that the force of the winch may be directed in an advantageous direction. In a variation, a guide is provided so that the winch may be more easily used to guide a trailer onto the hitch ball. Generally the winch and hitch feature may be used independently of each other or used together.

### BACKGROUND OF THE INVENTION

1. Field of the Invention

The present invention relates to vehicle mounted hitch receiver accessories, and more particularly, to a winch and frame with a hitch ball that attaches to a vehicle's hitch receiver.

2. Description of the Related Art

Several designs for hitch mounted winches have been designed in the past. None of them, however, includes a winch that can rotate relative to the vehicle and yet is removable from the bar while still retaining the hitch ball to attach a trailer.

Applicant believes that the closest reference corresponds to U.S. Pat. No. 5,072,962 issued to Webb. However, it differs from the present invention because the present invention provides for a winch assembly that is removable from the balance of the components which allows a user to move the winch assembly for security purposes while not affecting the hitch ball to attach a trailer.

Furthermore, in the present invention the winch assembly has the ability to rotate relative to the bar assembly allowing the full force of the winch to be selectively directed in the most advantageous direction. This feature in the present design also permits the use of a webbing material instead of a commonly used cable because the face of the winch can be turned toward the object being pulled instead of redirecting a cable through guides.

Because the winch assembly is separable from the balance of the components it can be removed for theft prevention, long haul towing, through inclement weather, exposure and other road contaminants that may damage or shorten the life of the winch assembly.

The removable nature of the winch in the present device also eases attachment and detachment of the device from a vehicle by permitting the device to be installed on a vehicle in two stages: first the bar assembly and then the winch assembly. For example, a winch of sufficient strength combined with the bar assembly may be too heavy for a single person to attach to a vehicle but separating the main components could allow a single person to attach the complete assembly to a vehicle by breaking the operation into two stages.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a vehicle mounted extended tow bar with a removable winch.

It is another object of this invention to provide a vehicle hitch mounted winch that can be easily rotated to face any of a plurality of predetermined directions.

It is still another object of the present invention to provide a hitch mounted winch with a unitary bar spanning from the hitch receiver to the ball thereby increasing strength and safety.

It is another object of the invention to provide a hitch mounted winch where the winch is removable without disconnecting the trailer for security and long distance transport.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an elevation view of a principal variation of the device as it might be engaged onto a vehicle. The vehicle is shown in broken lines and is not a part of the claimed invention.

FIG. 2 shows an elevation view of a preferred variation of the device.

FIG. 3 illustrates a perspective view of the winch assembly separated from the bar assembly.

FIG. 4 is a plan view representation of a variation of the device that includes a guide feature.

FIG. 5 is a perspective view of the winch assembly in line with the bar assembly.

FIG. 6 is a perspective view of the winch assembly aligned perpendicular to the bar assembly.

### DETAILED DESCRIPTION OF THE PREFERRED EMBODIMENT

Referring now to the drawings, where the present invention is generally referred to with numeral 10 in FIG. 1, it can be observed that it basically includes, inter alia, a hitch assembly 12, a winch assembly 14 and a spindle assembly 16. For a fuller understanding of how to make and use the device a vehicle 18, a receiver 42 and a pin 44 are also shown but are not part of the claimed invention.

Vehicles used to tow typically have a receiver 42 permanently mounted to the vehicle's 18 rear frame or bumper. Some vehicles also may have a similar receiver 42 affixed to the front of the vehicle 18. The present invention may attach to either the front or rear receiver 42 depending on the application.

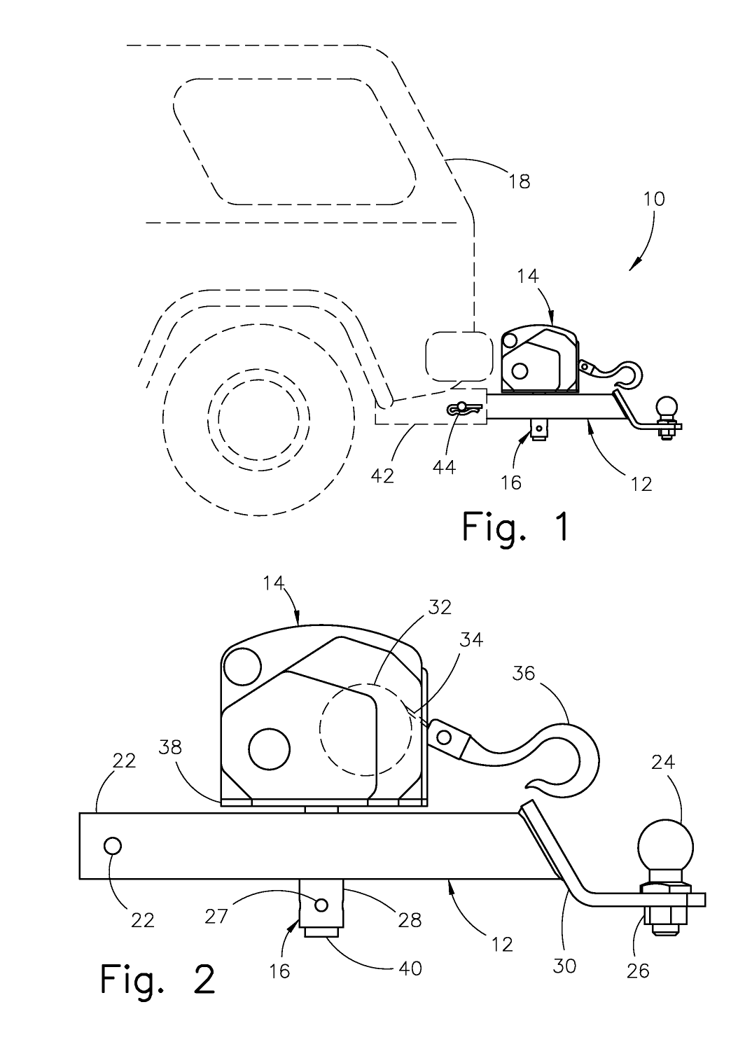

Now referring to FIG. 2 where more details of the various assemblies is shown to further include, inter alia, a bar 20, a bore 22, a ball 24, a nut 26, a bore 27, a sleeve 28, a tongue 30, a winch 32, a cable 34, a hook 36, a plate 38 and a spindle 40.

Looking now to FIGS. 1 and 2, in typical use of the device a first end of the hitch assembly 12 is inserted into the receiver 42 and is locked into position with a pin 44 that passes through bores (obscured by pin 44 in FIG. 1) on either side of the receiver 42 and through a bore 22 (shown in FIG. 2) on the hitch assembly 12. On a second end of the hitch assembly 12, opposite the first end, is a ball 24 onto which a common trailer may be attached.

In one variation a tongue 30 is present to lower the elevation of the ball 24 for certain applications such as if used on a larger tow vehicle. The ball 24 is affixed to the tongue 30 by means of a nut 26. The ball 24 may be any of the variety of commercially available sizes commonly used for towing trailers. In another variation not depicted in the drawings the ball 24 may be directly affixed to the bar 20 by means of a bore though the bar 20 at a second end of the bar 20 and affixed by a nut 26.

In a preferred variation of the device, the bar 20 is a unitary piece of strong and durable material, such as steel. The material and dimensions are such that the device is sturdy and safe enough to support the tongue weight and tension experienced by a typical trailer during normal use of the trailer. Certainly it would be strong enough to travel long distances over the highway, construction sites, stop and start traffic, boat ramps, dump sites and the wide variety of other applications that a trailer is commonly known to perform.

In a preferred variation of the device a sleeve 28 is affixed to the hitch assembly 12 through the bar 20. The sleeve 28 is dimensioned to snugly fit around the spindle 40 of the spindle assembly 16 so that the spindle 40 is permitted to rotate inside of the sleeve 28. Generally, the winch assembly 14 is affixed to the plate 38 of the spindle assembly 16 so that the spindle 40 is fixed relative to the winch assembly 14.

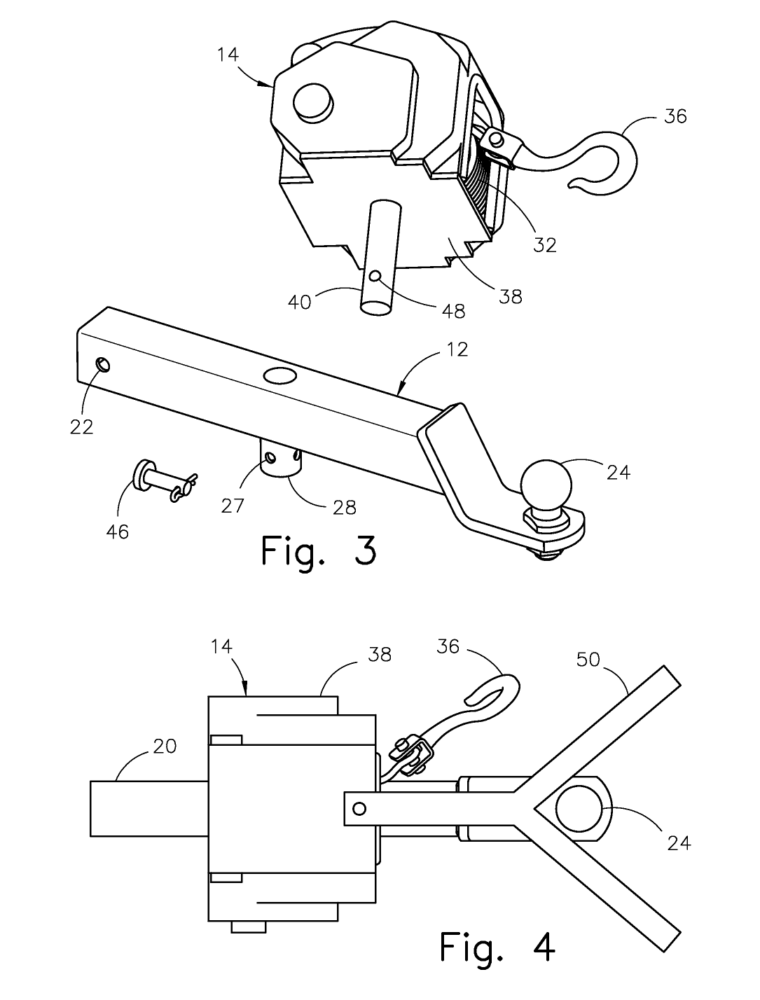

Referring to FIG. 3 where the winch assembly 14 is shown separated from the hitch assembly 12 and can be seen to include a bore 48 positioned at the end of the spindle 40 opposite the plate 38. The sleeve 28, in one variation, is affixed to and traverses the depth of the bar 20 and protrudes through the bottom of the bar 20 to expose a series of bores 27 spaced at predetermined intervals about the periphery of the sleeve 28 below the bar 20. The sleeve 28 is essentially a hollow tube dimensioned to accept the spindle 40.

A pin 46 is provided to penetrate bore 48 and any pair of opposite bores 27 on the sleeve 28. By inserting the pin 46 through said bores 27 the spindle 40 is locked relative to the sleeve 28 and therefore necessarily the bar 20. A plurality of bores 27 are arranged about the circumference of the sleeve 28 in pairs opposite each other so that the pin 46 can pass thorough any pair of opposite bores 27 and also the bore 48 on the spindle 40. Preferably there are at least four bores 27 but up to sixteen bores 27 may be beneficial for some applications.

To select the orientation of the winch assembly 14 relative to the hitch assembly 12 the spindle 40 is inserted into the sleeve 28 and the winch assembly 14 is rotated into the desired orientation and adjusted such that the bore 48 is aligned with a pair of bores 27 and then locked into that orientation with the pin 46.

In another variation of the device the bar 20 has a bore from the top through the bottom and the sleeve 28 is aligned with said bore and affixed to the underside of the bar 20. In this variation said sleeve has a multiplicity of bores 27 spaced at predetermined intervals about the periphery of the sleeve 28. The sleeve 28 and adjacent bore are dimensioned to accept the spindle 40 of the spindle assembly 16 yet allow it to rotate when the pin 46 is removed.

Similar to other variations, a pin 46 is provided to penetrate bore 48 and any pair of opposite bores 27 on the sleeve 28. By inserting the pin 46 through said bores 27 the spindle 40 is locked relative to the sleeve 28 and therefore necessarily the bar 20. To select the orientation of the winch assembly 14 relative to the hitch assembly 12 the spindle 40 is inserted into the sleeve 28 and the winch assembly 14 is rotated into the desired orientation and adjusted such that the bore 48 is aligned with a pair of bores 27 and then locked into that orientation with the pin 46.

Now referring to FIG. 4 where a top plan view of a variation of the device is shown to further include a guide 50. The guide 50 is generally ‘Y’ shaped and affixed to the winch assembly 14 and/or the hitch assembly 12 so that the forked end is held centered over the ball 24. This is particularly useful for drawing the tongue of a trailer over the ball 24 so that the trailer can more easily be attached to a vehicle for towing. In a preferred variation the guide 50 is removable to allow for easier and safer storage and trailer towing. Use of the guide 50 makes it possible to attach a heavy trailer to a vehicle with only a single person.

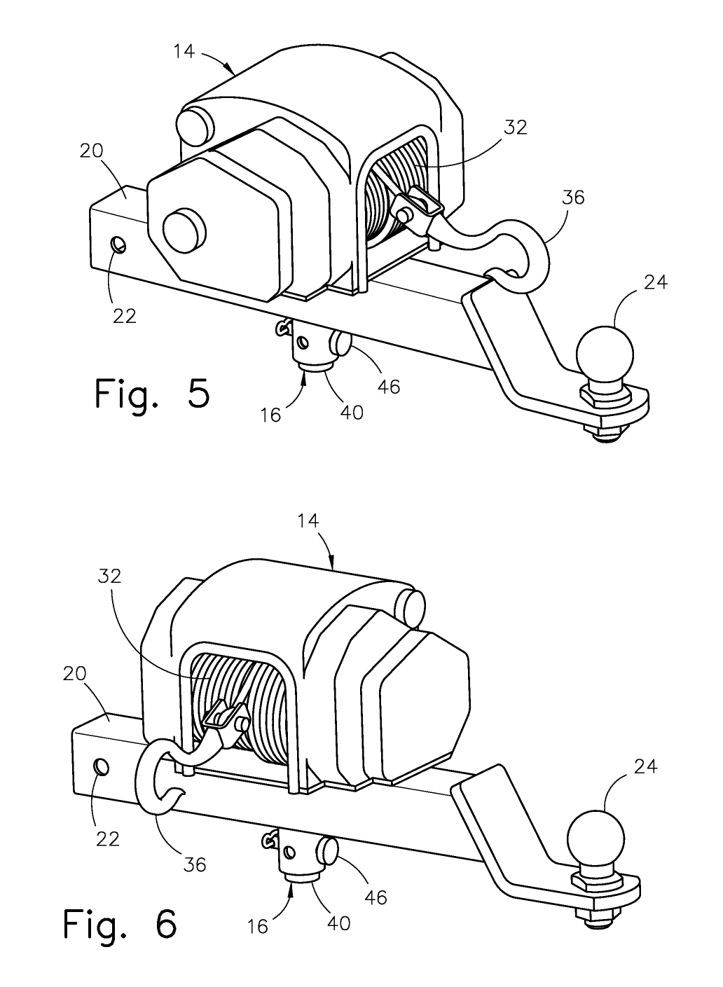

FIGS. 5 and 6 show an example of the winch assembly 14 locked onto the hitch assembly 12 at alternate orientations. FIG. 5 shows the winch 32 cable and hook 36 directed straight back from the vehicle it would be attached onto. This orientation may be useful, for example, to pull a trailer onto the ball 24 or if a trailer is attached to the ball then to pull an object onto the trailer. Alternately, FIG. 6 shows the winch assembly 14 facing the side of the bar 20 so that the force of the winch 32 is directed to the side of the track of the vehicle to which it is attached. The orientation of the winch assembly 14 as demonstrated in FIG. 6 may have advantages if, for example, the vehicle onto which the device is mounted slips over the ground when tension is applied by the winch when directed directly behind the vehicle. The winch 32 can then be oriented to draw perpendicular to the vehicle as shown in FIG. 6 so that the wheels of the tow vehicle may be oriented perpendicular to the force applied by the winch and would therefore be much less likely to slip.

Other contemplated advantages of having the winch 32 draw from various angles could include, by means of example, launching a boat at an awkward or unimproved boat launch, towing a landscape shredder with the hitch and using the winch 32 to draw heavy logs to the mouth of the shredder or aiding in hooking up the ball 24 to an oddly positioned or heavy trailer.

A safety feature of a safety chain fastening point may optionally also be present on the bar 20 between the spindle assembly 16 and the ball 24 to provide a point where safety chains that are present on many trailers can attached to provide a redundant attachment in case the trailer disconnects from the ball 24. Similarly, a chain may also be provided affixed to the bar 20 between the bore 22 and the spindle assembly 16 so that the invention can be safety chained to the hitch receiver assembly on the vehicle. Typically the winch 32 is electrically powered by a wired connection to the tow vehicle's battery and power system. Switches to activate the winch may be inside the vehicle cabin, on a wired or wireless remote control or on the winch assembly 14. For certain applications is may be desirable to have an independent and dedicated power supply, such as a battery, affixed to the winch assembly 14 or other appropriate area of the invention.

It can easily be appreciated that the winch feature of the invention could be used with or without a trailer as well as the trailer towing features of the invention may be used with or without the winch attached to the hitch assembly.

Optional accessories may include a removable fabric rain fly to cover the winch 32 and protect it from the elements while in storage or during transport. A storage bag may also be provided to protect the winch assembly 14 and its electronic components when it is removed from the hitch assembly 12 for storage. A strap may also be used as an alternate to the cable depicted in the drawings. Various capacity winches may also be available that are suitable to a variety of tasks.

In a preferred variation, the device may be described as a vehicle hitch receiver mounted device comprising a hitch assembly, a winch assembly and a spindle assembly where said hitch assembly is comprised of a bar having on a first end a means to securely and releasably engage into a standard vehicle hitch receiver and on a second end having a standard hitch ball where said spindle assembly is comprised of a first sub-assembly comprised of a spindle affixed at substantially the perpendicular to a plate and a second sub-assembly comprised of a sleeve vertically and permanently affixed to said bar between said first end and said second end of said bar where said spindle of said first sub-assembly dimensioned to fit into said sleeve of said second sub-assembly and when engaged into the sleeve said spindle is rotatable relative to said sleeve and a lock between said spindle and said sleeve is provided to fix the relative position of said spindle to said sleeve at any of a plurality of predetermined positions and said winch assembly comprises a winch and is affixed to said plate which is in turn affixed to said spindle and said winch assembly is separable from said hitch assembly when said lock is released.

Optionally, the device may be further characterized in that the winch is controlled from a wireless control switch. Optionally, it may be further characterized in that a safety chain is affixed to the hitch assembly and is attachable to a tow vehicle. Optionally, it may be further characterized in that an attachment point is provided on the hitch assembly to receive a trailer's safety chain. Optionally, it may be further characterized in that said hitch ball is removable and replaceable with different sized hitch balls. Any of these options may be included with the preferred deign alone or in concert with other optional elements.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A vehicle hitch receiver mounted device comprising a hitch assembly, a winch assembly and a spindle assembly;
Said hitch assembly comprised of a bar having on a first end a means to securely and releasably engage into a standard vehicle hitch receiver and on a second end having a standard hitch ball;
Said spindle assembly comprised of a first sub-assembly comprised of a spindle affixed at substantially the perpendicular to a plate and a second sub-assembly comprised of a sleeve vertically and permanently affixed to said bar between said first end and said second end of said bar;
Said spindle of said first sub-assembly dimensioned to fit into said sleeve of said second sub-assembly;
When engaged into the sleeve said spindle is rotatable relative to said sleeve;
A lock between said spindle and said sleeve is provided to fix the relative position of said spindle to said sleeve at any of a plurality of predetermined positions;
Said winch assembly comprises a winch and is affixed to said plate which is in turn affixed to said spindle;
Said winch assembly is separable from said hitch assembly when said lock is released.

2. A vehicle hitch receiver mounted device as disclosed in claim 1 further characterized in that the winch is controlled from a wireless control switch.

3. A vehicle hitch receiver mounted device as disclosed in claim 1 further characterized in that a safety chain is affixed to the hitch assembly and is attachable to a tow vehicle.

4. A vehicle hitch receiver mounted device as disclosed in claim 1 further characterized in that an attachment point is provided on the hitch assembly to receive a trailer's safety chain.

5. A vehicle hitch receiver mounted device as disclosed in claim 1 further characterized in that said hitch ball is removable and replaceable with different sized hitch balls.
